(19) United States
(12) Patent Application Publication
(10) Pub. No.: US 2016/0042648 A1
(43) Pub. Date: Feb. 11, 2016

(54) EMOTION FEEDBACK BASED TRAINING AND PERSONALIZATION SYSTEM FOR AIDING USER PERFORMANCE IN INTERACTIVE PRESENTATIONS

(71) Applicant: Ravikanth V. Kothuri, Frisco, TX (US)

(72) Inventor: Ravikanth V. Kothuri, Frisco, TX (US)

(21) Appl. No.: 14/821,359

(22) Filed: Aug. 7, 2015

Related U.S. Application Data
(60) Provisional application No. 62/034,676, filed on Aug. 7, 2014.

(51) Int. Cl. G09B 5/00; A63F 13/21; G06F 3/01; A63F 13/214; G06K 9/00; A63F 13/215; A63F 13/213; A63F 13/825; A63F 13/67; A63F 13/46; G09B 19/00; A63F 13/218

(52) U.S. Cl. CPC G09B 5/00; G09B 19/00; A63F 13/21; G06F 3/015; A63F 13/214; A63F 13/218; A63F 13/215; G06F 3/013; G06F 3/017; A63F 13/213; A63F 13/825; A63F 13/67; A63F 13/46; G06K 9/00255

(57) ABSTRACT

The present invention relates to a system and method for implementing an assistive emotional companion for a user, wherein the system is designed for capturing emotional as well as performance feedback of a participant participating in an interactive session either with a system or with a presenter participant and utilizing such feedback to adaptively customize subsequent parts of the interactive session in an iterative manner. The interactive presentation can either be a live person talking and/or presenting in person, or a streaming video in an interactive chat session, and an interactive session can be a video gaming activity, an interactive simulation, an entertainment software, an adaptive education training system, or the like. The physiological responses measured will be a combination of facial expression analysis, and voice expression analysis. Optionally, other signals such as camera based heart rate and/or touch based skin conductance may be included in certain embodiments.

### CROSS REFERENCE TO RELATED APPLICATION

This application claims priority to U.S. provisional application Ser. No. 62/034,676 filed Aug. 7, 2014, and entitled “Audience Feedback System Based on Physiological Signals for Interactive Conversations and Streaming Videos and Presentations”, owned by the assignee of the present application and herein incorporated by reference in its entirety.

### BACKGROUND

The present invention relates to creating an ‘assistive’ emotion companion for a user—an intelligent software system that gathers emotional reactions from various physiological sensors to various types of stimuli including a user's presentation, or a social interactive session including one or more participants, or an interactive application, and facilitates aggregation and sharing of analysis across various participants (and their respective emotion companions) for adaptively configuring subsequent experiences (or makes such suggestions) based on past behavioral and emotional traits exhibited in an application. The present invention relates to measuring the physiological signals of one or more audience members when exposed to one or more interactive presentations and creating an emotional analysis feedback chart for the interactive presentation and/or other interactive applications. The interactive presentation can either be a live person talking and/or presenting in person, or a streaming video (for example, Google Hangouts and Skype) in an interactive chat session, or even an educational training presentation wherein the presentation and the topics are adaptively modified as emotionally weak spots that are identified for a user or a group of users in prior parts of the presentation. An interactive application can involve one or more participants such as an interactive simulation, an entertainment software, an adaptive education training software, and interfaces that incorporate, but are not limited to, one of the following technologies: voice, face video or image, eye tracking, and biometric (including, but not limited to, GSR, heart rate and HRV, motion, touch and pressure) analysis. In one specific embodiment, the physiological responses measured will be primarily a combination of facial expression analysis and voice expression analysis (and in some applications, optionally including eye tracking and biometric analysis). Optionally other signals such as camera based heart rate and/or touch based skin conductance may be included in certain embodiments.

The increasing rate of advancement in the speed, small size, and flexibility of microprocessors has led to a revolution in sensor-enabled technologies. These sensors are now being applied to a range of industries such as fitness trackers (FitBit, Mio, Nike or Jawbone creating step counters and heart rate trackers), smart homes (power, motion and climate sensors to optimize home conditions), mobile communications (GPS, motion and even eye tracking cameras in smart phones) and even toys and games (gyroscope-enabled mobile gaming or dolls with pressure sensors to understand if they are being picked up or held or audio sensors to identify commands from the child playing with the toy).

While these products often include image, audio, or even biometric sensors, the sensor-enabled technologies can be used to understand:
The environment
The physical state of the user
The content, but not context, of what the user is trying to communicate

However, the existing sensor-enabled technologies do not use the sensors to evaluate the emotional state of the user and to generate appropriate responses to enhance the overall experience.

In both online and offline scenarios, the interaction between the game, virtual pet, or toy and its owner are limited to visual, voice recognition, text, button-based and other tactile input methods. In the instances where voice is used, only the language itself is considered, not the emotional features of the delivery of the language. The virtual pet cannot distinguish between a calmly stated word and an aggressively yelled word nor can it distinguish between the politely phrased word and aggressively stated command edged with a threat.

Further, the cameras are used to take pictures or video, generate augmented reality visuals, recognize movement, objects and environmental items or conditions. The camera is not, however, used to empower the objects such as a toy, a pet, or a game to understand the emotions of the player, owner, or others that may interact with the objects. The objects cannot identify a smile and use it to determine the user's emotion.

In ‘Speed Dating’ events, without revealing any contact information, men and women are rotated to meet each other over a series of short “dates” usually lasting from 3-8 minutes. At the end of each such short dating stint, the organizer signals the participants to move on to the next date. At the end of the event, participants submit to the organizers a list of who they would like to provide their contact information to. If there is a match/interest from both sides, contact information is forwarded to both parties. Contact information cannot be traded during the initial meeting, in order to reduce pressure to accept or reject a suitor to his or her face. Various online versions of this speed dating also exist where participants interact through video, chat, text, or online live audio conference systems including, but not limited to, Skype, Google Hangouts, Adobe ConnectPro, WebEx or Joinme or other technological tools.

In some cases, the various interactions between dates may be spread out into online as well as in-person interactions. In each of these cases, both online and/or in-person events, what is missing are tools to store a log of the overall interaction of the ‘dates’ (participants) without compromising privacy. There is a need to log the conversation history registered between the parties, as well as how each of the listening/viewing participants is reacting to the presenting/conversing participant. In an in-person speed dating event, where a first participant meets a number of second participants, it may be difficult to remember and rank objectively all the second participants that a first participant meets and in some cases might just be based on memory and likability of the second participant. In a 2012 study [1], researchers found that activation of specific brain regions while viewing images of opposite-sex speed dating participants was predictive of whether or not a participant would later pursue or reject the viewed participants at an actual speed dating event. Men and women made decisions in a similar manner which incorporated the physical attractiveness and likability of the viewed participants in their evaluation. In another study, Drs. Sheena Iyengar and Raymond Fisman [2,3] found, from having the participants fill out questionnaires, that what people reported they wanted in an ideal mate did not match their subconscious preferences. This confirms the need for diving into the subconscious readings of participants to live interactive sessions with other participants.

An unrelated but more generalized application is a typical web conference session such as from a Skype session, a Google Hangout, Joinme, WebEx or Adobe ConnectPro, where online participants take turns to be a ‘presenter’ role and the rest will be in ‘viewing’ (or listening) mode. A typical session will have the various participants switching between presenter and viewer roles as needed. Currently, there exist no mechanisms to characterize how well the overall session fared, compared with other sessions in the past, of the same group, or across various groups. Besides, there is no ‘objective’ feedback that could be passed to participants to improve the engagement of the group to their individual ‘presenter role’ through communication. It is also not clear how enthusiastic the audience was/is to various parts of the session (which could be various alternative proposals), and/or to various presenters. Given the nature of such conferences, it is manually impractical to track every participant's reaction to every piece of information presented in a manual watch-the-face, watch-gesture type mechanisms.

A need exists for more automated mechanisms for the tracking of sessions across participants and to provide real-time feedback from the other participants' reactions.

In this context, a number of ideas are being explored in various industries. Several researchers have explored the use of just facial coding in speed dating. Other researchers and companies have used just used emotion detection in expressed audio for customer relationship management in phone interactions. Some other researchers are exploring the use of these technologies in single person interaction in mobile retail or market research. The proposed invention relates to one or more persons in non-mobile-retail and non-recruit based media and market research industries (i.e., excludes any applications for single person monitoring in retail for mobile devices, or media/market research applications that recruit people explicitly for such research). Rather, it is for monitoring responses during natural interactions, whether in person or online, to provide an understanding of the emotions conveyed during those interactions to assist said interaction in real-time or to inform a set of follow-on decisions after the interaction.

Most facial coding software expects the participant to avoid moving the head more than 15 degrees so that the responses can be “comparable”. As there is a change in facial orientation across the various frames, the facial action units may or may not be readily comparable and hence the resulting facial coding software output for the various emotions such as joy, surprise, anger, sadness, fear, contempt, disgust, confusion, or frustration may significantly change (sometimes erroneously). For example, a smiling participant can be evaluated by the system as high on ‘contempt’ or ‘disgust’ (smrik) instead of ‘joy’ just because his face is rotated to the right slightly. This problem arises from using a single camera. If multiple cameras are used and facial coding software output is evaluated “naively” from each camera, it will require as many times more computing power.

This present invention combines various technologies primarily without requiring specialized biometric monitoring hardware; instead, this invention can use nearly any video and/or audio capture device such as webcams and microphones (or latest wearable gadgets such as google glass) for primarily gathering and combining (1) facial coding expression from camera (in current devices) from a number of vendors such as Emotient, Affectiva, RealEyes, nViso, or other open source engines, and (2) voice expression from embedded microphones (in current devices) from a number of vendors such as Cogito, Beyond verbal or open source voice expression detection engines such as OpenEar. It may also integrate one or more of the following: (3) camera-based heart rate, (4) a camera-based eye tracking to see where a participant is looking (the emotion at a location could then be aggregated across participants on location basis, that is where they looked on a presentation/other participant), (5) a bracelet, watch or other form-factor based wearable device (ios, android or other platforms) interfacing with one or mobile or computer devices for capturing, skin conductance (also known as Galvanic Skin Response, GSR, Electrodermal Response and EDR) and/or heart rate, SpO2, and/or skin temperature and/or motion, (6) and in some optional cases other wearables for monitoring other signals such as eeg.

### SUMMARY

The present invention is related to a system and method that can act as an assistive emotion companion for a user wherein the system is designed for capturing emotional as well as performance feedback of first participant participating in an interactive session either with a system or with a second presenter participant and utilizing such feedback to adaptively customizing subsequent parts of the interactive session in an iterative manner. In one embodiment, the system continuously tracks emotion signals which consist of facial coding, voice expression from cameras, microphones and optionally, heart rate and skin conductance from an external GSR sensor for the duration of the interactive session. In one embodiment, the system creates an array of emotion expressions across all the emotion signals for each time instant of the session duration for each participant. In one embodiment, the participants are dynamically labeled as ‘presenters’ and ‘viewers’: if the participant is talking, the participant will be labeled as presenter; otherwise as a viewer. The session can be divided into sub sessions, which include the first 30 s (to mark the first impressions), and potentially any “speaking” sub sessions of presenters (continuous speaking durations of 15 s or more can be considered as speaking sub sessions, to eliminate unwanted short speaking switches such as during a question and answer session), or other explicit user-identified sub session. In an embodiment, after the session ends (or, if possible, during the session), the system may create emotion feedback analysis for each sub session. The emotion feedback analysis may either be individual traces or aggregates of all emotion signals across all viewing participants signals ‘during the sub session as well as during any question & answer subsequent to the sub session and before the next sub session’. In one embodiment, the emotional feedback analysis is plugged into sessions that are carried out across web-conference and IP video tools such as, but not limited to, Google Hangouts, Skype, ConnectPro, WebEx, and joinme. This report of emotion analysis for sub sessions could be used either as feedback or in decision-making In another embodiment, the emotional feedback analysis is carried out in speed dating and other dating sessions where the emotion responses of one or more second participants to a first participant's interaction are analyzed and presented back to the first participant. This report across a set of ‘second’ participants could be used by a first participant to aid in identifying relevant candidates for further exploration possibly in subsequent sessions. Alternately, the report could be used by a first participant to alter the topics, his/her way of communicating and so on for subsequent dates. It might also give them an explanation of what happened when a date that they were interested in, had not ‘matched’ them in speed dating.

In another embodiment, the emotional feedback analysis can be used in an interactive video gaming activity to enhance the realism of the user's relationship with an object, such as a virtual pet, participating in the interactive video gaming activity. The changes in the biometric responses can be used to observe the behavioral pattern of the object and the responses can be used as the primary means of input to control the behavioral pattern.

In an embodiment, the emotional feedback analysis system can be used to track, analyze, store, or respond (or some combination) to the behavior pattern of the object in response to the user's emotions either when the user communicates directly to the object or around the vicinity of the object. Further, the emotional load of the communication can be a direct means of control for the virtual pet or can be used as an input along with traditional or other non-traditional controls.

In an embodiment, storing and reporting the user's emotional experiences with the object, (such as a virtual pet) enables self analysis or analysis of the data by a parent, guardian, care giver or medical or psychiatric professional to potentially aid in therapies, mood disorders, understanding, change in care or disorders, diseases and conditions that affect the user's emotional capability.

In one embodiment, a method of utilizing the emotional tone of a user in his or her interactions with a virtual pet or near the virtual pet comprises: analyzing the emotions inherent in vocalized interactions (analyzing features including, but not limited, to the pet user's or other's vocal tone, pattern, style, speed, character, responsiveness).

In another embodiment, a method of utilizing the emotions expressed on the face of the user in his or her interactions with a virtual pet or near the virtual pet comprises: analyzing the emotions inherent on the face (analyzing features including, but not limited to, the pet user's or other's facial expressions captured using computer vision to analyze the features that typically comprise a FAC, Facial Action Coding, analysis).

In another embodiment, the emotional feedback analysis can be used in the adaptive education training system, wherein the participant's/learners emotional expression is tracked while the participant is answering a set of questions associated with the educational material. Further, based on the behavior and inferred topics, the system can assist the participant to adapt to address the weak areas. Further based on the behavior and inferred topics, the training system can take appropriate actions such as presenting new set of stimuli to “drill-down” with more additional training on topics that the participant is inferred to be weak (scored low) or alert the tutors and other systems.

In an embodiment, the machine learning model/techniques that are available in the market can be integrated with the assistive emotional companion system to enhance the training data sets that is deployed by the machine learning models. Based on the physiological patterns identified by the assistive emotional companion system, while the user is using the training data sets, the “Feedback Incorporation Module” (and inference engine) supported in the assistive emotion companion system can be used to detect the misleading information delivered through the interaction presentation/interactive session. Further, the detected misleading information can be corrected or improved subsequently either by providing additional examples, samples, or relevant questions through the machine learning models. For example, when an educational training is delivered to the user, based on the eye tracking pattern observed by the user while addressing a set of explicit questions, the content of the educational training, deployed by the machine learning model, can be corrected or improved by providing more relevant sample, examples, and/or questions.

Other objects and advantages of the embodiments herein will become readily apparent from the following detailed description taken in conjunction with the accompanying drawings.

### BRIEF DESCRIPTION OF THE DRAWING(S)

FIGS. 1 and 2, according to an embodiment of the present invention, illustrates two application scenarios of the invention, matching the emotion profile with other user's emotion profile to determine close compatibility.

FIG. 3, according to an embodiment of the present invention, is a system overview of components used to implement the proposed invention.

FIG. 4, according to an embodiment of the present invention, is a flow-chart used to explain the process of generating near real time emotional feedback in conversations, web conferences, and presentations.

FIG. 5, according to an embodiment of the present invention, depicts the method of capturing facial expression using one or more cameras to evaluate the facial response or facial coding output.

### FIGURES—REFERENCE NUMERALS

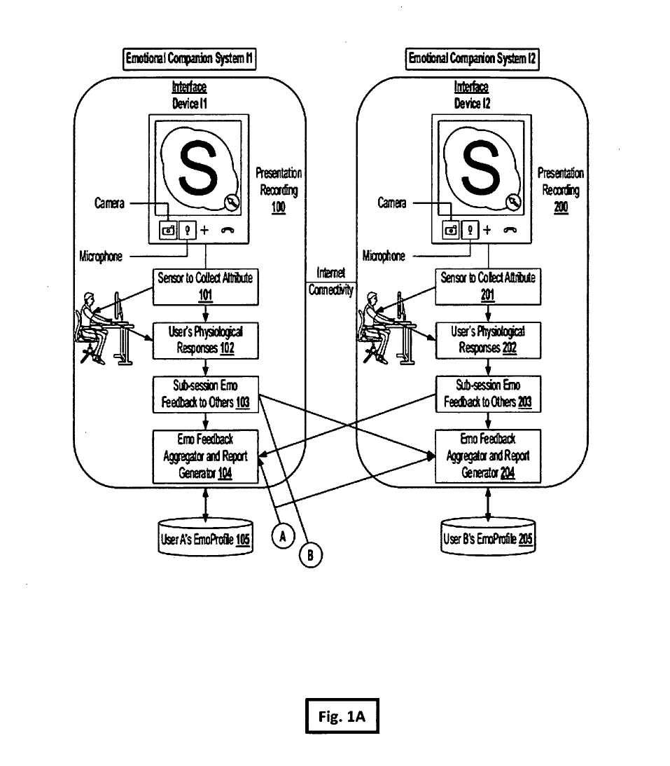

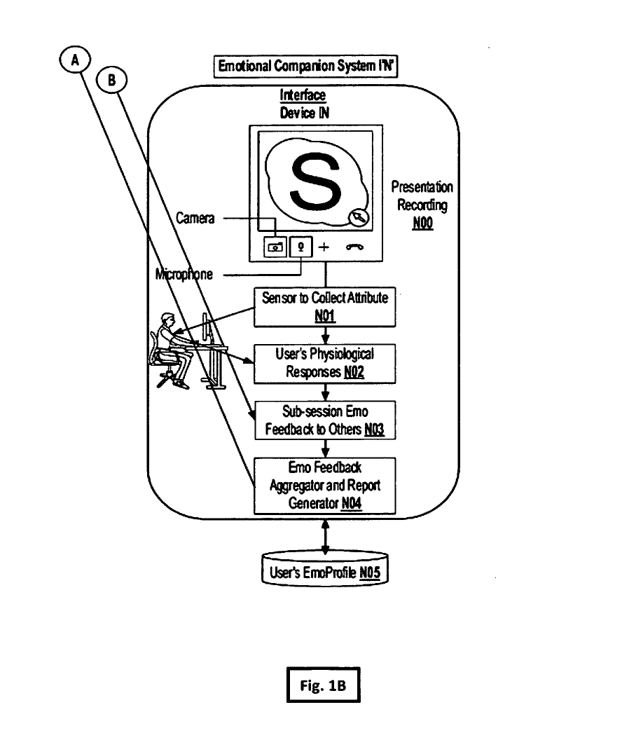

In FIG. 1, the following identifiers are used.
I1, I2, . . . , IN: For each participant 1, 2, . . . N of N participants, Interface Device (or devices) for facilitating an interactive session, data gathering, feedback reporting. These will be referred to as ‘stations’
100, 200, . . . N00: Web-conference/IP Video interface, and any content presentation/interaction/chat recording for session and subdivision into sub-sessions. This content (excluding any participant face videos) is overlaid with emotion-feedback
101, 201, . . . N01: Sensors associated with Device (s) 1, 2 . . . N to collect attributes of a participant. These include camera (s) for facial expression capture, optional heart rate capture, optional eye tracking, as well as microphones for voice capture (for identifying speakers and demarcating sub sessions and also for voice-emotion detection) from closest participant, and optionally skin conductance sensors. These sensors (cameras, gsr, . . . ) may be explicit units or embedded units in other wearable devices such as android-wear or other wearable gadgets, biometric watches, wristbands, or touch-based mobile devices/laptops/desktops, and facial coding, eye tracking, heart rate tracking from cameras or google glass type devices (or other computer devices), voice sensors from explicit microphones or embedded units in google glass or other computer devices
102, 202, . . . , N02: Participant's Physiological responses from number of sensors
103, 203, . . . N03: Sub-session level responses exchanged across participant stations
104, 204, . . . N04: Cross-participant Aggregator and subsequent near-real-time/live EmoFeedback Report generator

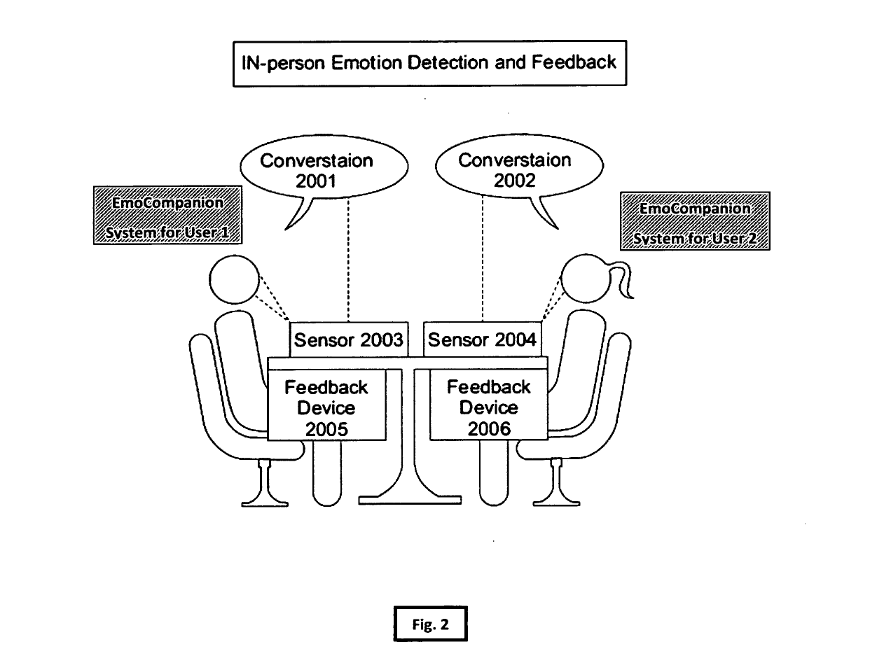

In FIG. 2, the following identities are used:
2001: Conversation of participant 1 (as recorded by a recording device)
2002: Conversation of participant 2 (as recorded by a recording device)
2003: Sensors for participant 1 measuring physiological responses to conversation 2002 from participant 2.
2004: Sensors for participant 2 measuring physiological responses to conversation 2001 from participant 1.
2005: Near real-time emotional feedback presented back to participant 1 based on response from participant 2 for immediately preceding (in time) conversation 2001 of participant 1. This could be used by participant 1 to alter his/her subsequent conversation 2001.
2006: Near real-time emotional feedback presented back to participant 2 based on response from participant 1 for immediately preceding (in time) conversation 2002 of participant 2. This could be used by participant 2 to alter his/her subsequent conversation 2002.

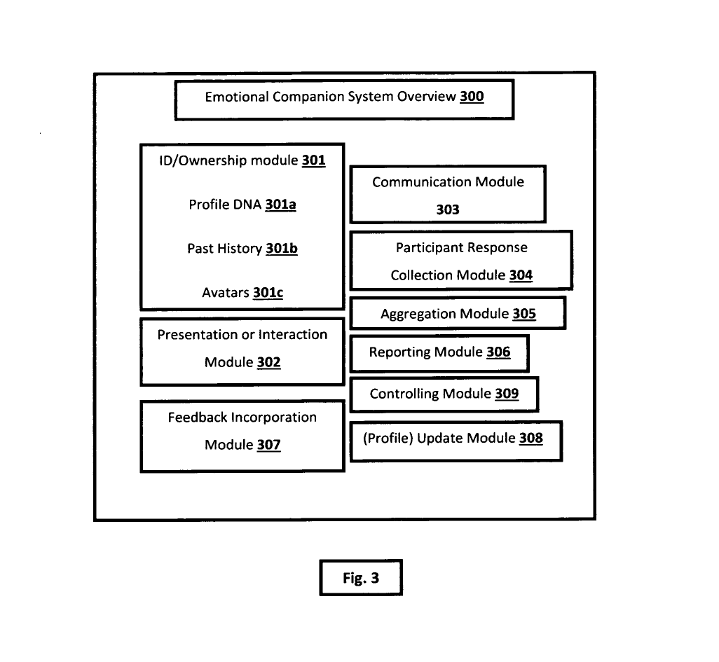

In FIG. 3, the following identities are used:
300: An Emotional Companion System components overview
301: An ID/Ownership module for the Emotional Companion System, which determines the owner of the system along with the details of the owner, such as an emotional profile of the owner (if it exists, and if not available, the module creates and updates the behavioral information that is gleaned from live interactive sessions), a past session history, and so on. Further, most of this information may be stored on a cloud-based server and accessed by a user's interactive device appropriately.
301a: Emotional profile associated with the owner user.
301b: Past session and other types of relevant historical information associated with the owner user.
301c: Avatars and other personal representative information for the owner user, which can be used to allow the emotional companion system to participate in ‘second life’ type online games and other activities utilizing the owner's emotion profile and the behavioral information by representing the owner and his personality in terms of emotions and other personal attributes that are captured and gleaned over time.
302: Presentation or Interaction Module determines the stimulus to be presented appropriately. The stimulus to be presented may be modified from the feedback generated by responses and as determined by feedback incorporation module 307. Further, the Presentation module is also responsible for interfacing with various online conference tools such as google hangout, skype, other types of meeting tools, interactive dating tools, social media applications, and interfaces.
303: Communication module is responsible for interfacing with corresponding modules supporting the emotional-companion systems comprising of various participants for the sake of sharing and aggregating across various participants. This includes storage and network transmission/distribution (of responses across participants) module.
304: Participant response collection module will obtain responses from the participants participating in the interactive presentation/interactive session. By default, it collects the responses from the owner participant and transmits to other systems as needed. Alternately, the system may be configured to track the responses of a participant other than owner after obtaining appropriate permissions from the monitored participant (in which cases, that data may only be used for analysis and adaptation but will not be used to update the owner-specific information such as the owner's emotional profile and so on).
305: An aggregation module can utilize a running baseline of specified seconds within each sub session (or a first sub session) for each speaker to normalize the cross-participant responses to standard scales for all physiological response signals.
306: Reporting module reporting near real-time feedback for each sub session (either as it is happening or after the sub session is over).
307: Feedback incorporation module to affect subsequent portions of a multi-part presentation or a live interactive session, wherein the session may be divided into multiple parts either by duration (say several minutes each) or by topic.
308: Update module wherein the owner's profile and history and other information are updated as appropriate assuming that the feedback responses are collected for the owner.
309: A Controlling module managing the entire interactive session across all participants.

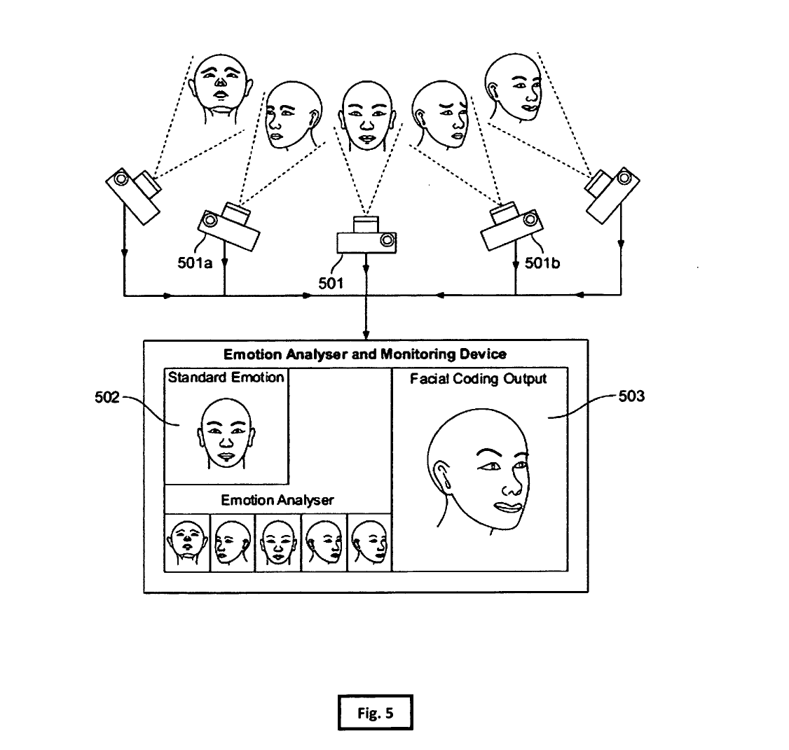

In FIG. 5, the following identities are used:
501: A camera placed centrally to capture the facial expression.
501a: A camera placed on the left of the centrally placed camera to capture the facial expression that is tilted.
501b: A camera placed on the right of the centrally placed camera to capture the facial expression that is titled.
502: A near-frontal image of the facial expression captured by the camera.
503: A facial coding output determined based on the analysis of the facial expressions captured by the camera.

### DETAILED DESCRIPTION

In the following detailed description, a reference is made to the accompanying drawings that form a part hereof, and in which the specific embodiments that may be practiced is shown by way of illustration. These embodiments are described in sufficient detail to enable those skilled in the art to practice the embodiments and it is to be understood that the logical, mechanical and other changes may be made without departing from the scope of the embodiments. The following detailed description is therefore not to be taken in a limiting sense.

Referring to FIG. 1, depicts the system for providing emotional feedback tied/plugged into web-conferencing tools and systems. It depicts N participants each sitting in front of a computer system (on any computer system such as desktops, laptops, mobile devices, and appropriate versions of wearable enabled gadgets or even cameras and/or microphones remotely connected to said devices), with an Interface application 1, 2, . . . N, that connects to each of the other N-1 participants via a network system. For example, the Interface Device 1 (and correspondingly 2, . . . N for other participants which will not explain further separately as the technical functionality is identical but catering to the specific participant being monitored) includes a presentation and capture tool 100 (as part of, or separate from, a web-conference tool system like Google Hangout, Skype, ConnectPro, Joinme etc.) for presenting other participants' interaction and to record the vocal part of it for overlaying with emotional feedback. Based on which participant, say K, is leading the conversation, that participant may be designated the speaker for that time period and all others become viewers and this conversation can be part of a sub-session led by K unless another participant takes over as presenter explicitly (or by speaking for a noticeable time). Any interactions from other participants that are short (e.g. of 10-15 s with taking presenter role) can be treated as the discussion/interaction/question and answer part of the same sub-session. In this way, the actual web-conference ‘session’ is demarcated into ‘sub-sessions’ for which emotion feedback will be captured and displayed in near real-time. The system also has associated physiological sensors 101, which may include camera (s) for facial expression capture, optional heart rate capture, optional eye tracking, as well as microphones (either built into or separate from the cameras) for voice capture (for identifying speakers and demarcating sub sessions and also for voice-emotion detection) from closest participant, and, optionally, other biometric sensors such as skin conductance sensors. These sensors (cameras, gsr, . . . ) may be explicit units or embedded units in other wearable devices such as Google glass or biometric watches, wristbands, or other touch-based devices and even non-touch based devices that may present additional sensors or capture modalities. Using these sensors, the system 1 can capture and store the physiological responses 102 of participant 1 (likewise other systems for other participants). The emotion responses are exchanged dynamically between systems effectively as bits and bytes to minimize transfer times and facilitate fast exchanges using a number of latest distributed algorithms. The emotion responses may be exchanged after every time instant or after every m time instants, called a measuring interval, (including the transfer delay and processing delay, the value of m will determine the overall ‘lag’ of emotion feedback; if m is set to almost every second, the lag may be very close to the processing delays and efficient methods are employed to ensure this but there may be a trade-off between how much information is transmitted and the granularity of ‘in’, the measuring interval, and may be optimized based on what platform of devices are used and how long the sub-sessions are measured to be, on average). The measuring interval may also be set based on the duration and demarcation of the content that is presented and may vary across the session in certain applications.

The physiological response feedback 102 is converted to normalized scales of emotion feedback 103 for each signal by a number of techniques that involve discretization/binning (in Data mining literature), change in signal (as reported by Lang et al.) and scoring off of (the average and stddeviation of) an initial baseline window, or continuous moving/overlapping baseline windows as typically used in statistics or novel combinations and variants thereof.

Some of these techniques for normalization may be used for all the physiological signals, or only for a subset of signals. For example, for some of the signals such as facial coding just discretization/thresholding may be enough as the outputs from vendors (such as Emotient) may represent intensity scores in a fixed range. On the other hand for voice expression from some vendors such as openEar, a normalization using baseline windows may be utilized. The normalized emotion feedback from participant 103 is then exchanged with other systems in an efficient fashion. At the end of each m seconds, the speaker/presenter participant is identified, the emotion feedback from all viewer participants for preceding m seconds can be ‘aggregated’ (removing any outliers if there are enough participants) across all participants and optionally across all signals 104 and reported. The reported traces for the prior m seconds (where m is the measuring interval and is typically of 1-2 seconds) may contain one or more of the following: (1) aggregated-across viewer participant traces for each of the emotion feedback signals (which are essentially normalized raw signal data integrated across vendors and will include one or more of facial coding outputs (joy, anger, sadness, fear, contempt, disgust, surprise, positivefac, negativefac), openEar voicecoding outputs (voice valence, voice arousal and so on), or other beyondverbal outputs (mood, temper, composure, etc.) or cogito outputs (speakingrate, dynamicvariation, etc), or physiological outputs (gsr, and so on), as well as (2) derived constructs from the combinations of such discretized raw signals: These derived emotion constructs include but are not limited to:
Combination of facial coding outputs and gsr such as highly positive' (for example, this may be a combination of high gsr and high positive facial expression), and ‘highly negative’ (could be a combination of high gsr and high negative_facial expression and low positive facial expression) and so on.
Combination of voice coding outputs and gsr
Combination of facial coding outputs and voice coding outputs
Or other possible combinations and techniques that may be learned (using machine learning techniques) from user's behavioral data in each of the various applications that are mentioned in this patent.
Specific constructs that are captured include but are not limited to: valence, arousal, mood, composure, temper, interest, nervousness/anxiety, joy, anger, sadness, contempt, disgust, fear, surprise, positivefac, negativefac, fatigue, and frustration

If voice expression is detected for those m seconds as part of a discussion/interaction/question & answer, those signals could be passed in as is, along with aiding in the derived measures: and so on, the valence, arousal measures from OpenEar can be used directly and combined as a weighted measure with the lagged response of non-speaking participants; alternately the dynamic rate of speech is used to indicate a form of arousal/excitement. These measures are reported back on the screen of the presenter, participant, or to a subset of participants, or to a completely external group of users who need to monitor how the interactive session is going on. At the end of each session, or a sub session, an aggregated across-time report of the various emotions (raw and derived) across participants can be generated as indications of which emotions dominated in that sub session. The feedback after each “m” seconds may be used to adaptively change the content to be presented in subsequent sub sessions of the interactive session or to provide feedback to the presenter, participant or others. Alternately, the reports may be stored and utilized subsequently either to aggregate at the end of the session or in other meaningful ways that may be relevant to an application.

Referring to FIG. 2, illustrates a scenario of matching the emotion profile of one user with other user's emotion profile to determine close compatibility. Here the system may be used to monitor reactions of two participants and pass real-time feedback to each other to facilitate or simply inform the conversations. Alternately, the system could also be used in speed dating, or friendship making, or executive matchups (at conferences), where one participant talks to a number of other participants and tries to remember which of those participants that he/she talked to are worth pursuing subsequently based on how much emotional interest they showed. Alternately, the same mechanism could be used to identify candidates in interviews among a set of candidates, or to identify potential rattling topics in an investigative conversation. Alternatively, the same mechanism could be used as more of an entertainment device, understanding how the other participant feels during a conversation as a form of entertainment—the enhanced transfer of information during a conversation (the combination of the conversation itself and the trace of how emotions are playing out) may be more entertaining than the conversation itself. Alternatively, the same system may only provide emotional analysis in a single direction where only one of the participants may be able to analyze the emotions of the other speaker. This may have highest value in areas such as police, security and criminal interviews or even sales and negotiations discussions. Alternatively, a participant may only see their own emotional responses enabling them to better train how they can speak and interact with others, which may have special value in areas such as autism treatment (training those with a spectrum disorder to better communicate with others).

In addition to the applications mentioned in FIGS. 1 and 2, in one embodiment of the system, one or more second participants could be communicating with a ‘system’ instead of a live person as a first participant.

Specific application industries include security and investigative agencies such as the TSA where an officer at customs detect if an incoming person is nervous, or if there are any noticeable discrepancies to his specific questionnaire to the person. Other industries as mentioned above include video-chatting as integrated in web-conferencing tools, as well as various online and offline dating services/applications.

In one embodiment of the system, one or more second participants can communicate with a system instead of a live person as a first participant.

In FIG. 2, a person to person interaction is depicted. This could be part of a series of 2-person conversations to facilitate one of the applications mentioned above. Participant 1 makes a conversation 2001 to which participant 2 reacts and his reactions are recorded by sensors 2004 and these responses are normalized and communicated to participant 1's feedback device 2005 which reports them as near real-time feedback for the topic 2001 of participant that was just discussed. The same ideas as in the above paragraph on measuring interval and dividing the conversation into sub sessions of each participant can be employed here as well. Likewise, when participant 2 makes a conversation 2002, participant 1's responses are captured by sensors 2003 and normalized responses to participant 2's feedback device 2006 in a near real-time fashion. The participants can choose to get feedback in near real-time fashion to possibly adapt the conversation appropriately, or just not be disturbed for the conversation and get it in the end of the session (essentially, the reporting interval can be customized as needed).

A fixed participant 1 can be ranked against each other and selected as depending on the application needs (for example, in a job interview with a recruiter participant 1, the participant 2 that responds best to descriptions of the job could be selected).

In one special embodiment of the invention, the participant 2's responses to their own conversation can be recorded and conveyed to participant 1 in certain applications. A limited use of this is already in use as lie-detector applications in investigations, but in this embodiment, in addition to skin-conductance, other signals from voice expression denoting anxiety, distress, or from facial coding such as anger, disgust, contempt, fear, sadness, joy, etc could be utilized. The same (using a participant's reactions to their own conversations can also be used in the application of FIG. 1 as well as an additional set of output traces/measures).

Referring to FIG. 3, shows various modules in the system.

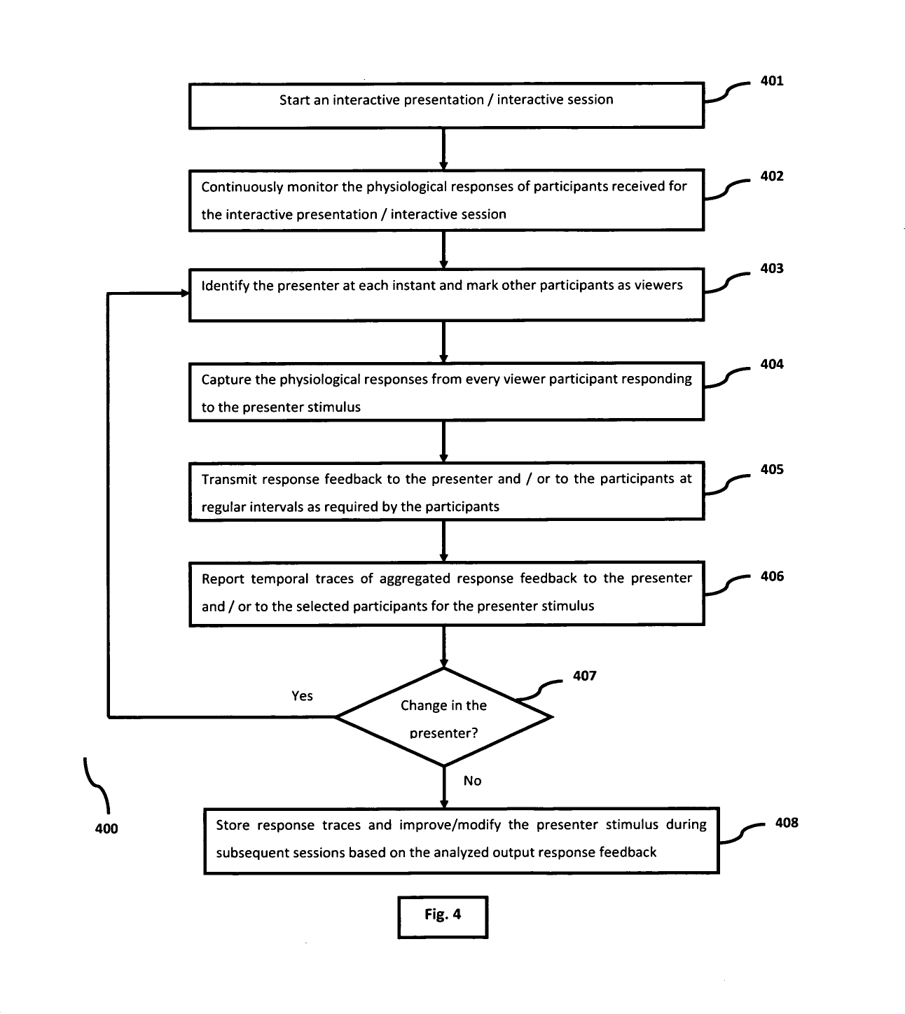

Referring to FIG. 4, shows a possible set of workflow for the applications described in FIGS. 1 and 2. Initially, at step 401, the method 400 initiates an interactive presentation/interactive session on an interactive device. As the interactive presentation/interactive session is initiated, at step 402, the method 400 starts monitoring the physiological response received from the participants for the interactive presentation/interactive session. At step 403, the method 400 continuously identifies the presenter and marks the remaining participants as the viewers. Upon identifying the presenter and the viewers, at step 404, the method 400 captures the physiological response received from the viewer for the presented stimulus at every instance. At step 405, the method 400 transmits the received response to the presenter and to the selected viewers at regular interval as required by the presenter and/or the participants. At step 406, the method 400 determines the temporal traces of the aggregated response feedback and reports the feedback to the presenter and/or the selected participants for the presented stimulus. At step 407, the method 400 checks for the change in the presenter. If the method 400 determines that there is a change in the presenter, then the presenter at that instant is identified and other participants are considered to be the viewers. Otherwise, at step 408, the method 400 stores the response traces and allows the interactive presentation/interactive session to be modified during subsequent sessions based on the overall response feedback analytics determined for the presenter stimulus.

Referring to FIG. 5, shows the method of capturing facial expression using one or more cameras 501, 501a, and 501b to evaluate the facial response or facial coding output 503. In one embodiment of the invention, the system will have one or more cameras to capture the face, and zero or more eye trackers in a near-frontal position every moment irrespective of how the participant is moving his head. The video frames from multiple cameras 501, 501a, and 501b are compared to identify, pick, and synthesize (if needed) the most near-frontal image 502 of a participant for the purposes of evaluating facial response and to get consistent facial response measures that are comparable across various evaluation frames during a viewing period. The proposed method handles one of the intricate issues in facial coding where the raw signal data changes (and becomes unusable) if a participant tilts his or her head.

In another embodiment of the invention, the system can comprise an array of cameras placed on a monitoring device to capture the face at multiple degrees of horizontal and vertical translation, as well as an overall rotation. For example, a camera fixed to the left 501a, to the right 501b, one to the top, one to the bottom of a central camera 501 to capture various facial-angles of a recorded participant.

In one embodiment of the invention, the frames from each camera are compared with a near-frontal, ‘still shot’ image 502 of the participant captured at an initial moment by explicit instruction (or obtained by scanning across various frames during an initial first viewing period of a baseline stimuli). For each camera, at each subsequent second video frame, the image of the participant in the second frame is compared with the near-frontal ‘still shot’ image 502 on that camera. Each ear of the participant is compared with the corresponding ear on still shot to determine any rotation, tilt and adjusted accordingly. Likewise, a comprehensive cross-camera evaluation of the frames is performed, and a new “test” frame is synthesized (either by choosing the frame from the camera that is best aligned with the face, or by stitching together from various cameras). The camera that has the most rectangular footprint on a video frame where the image is not tilted (or least “tilted” which can be detected by comparing the position and footprint of the eye-sockets and comparing the y-position of each of those footprints of the eye sockets with respect to each other), and the frame that is not skewed (which is determined by comparing the right-side-face v/s left-side-face (by comparing the sizes of the right ear v/s left ear) and choosing the frame that has least distortion between left and right sides, is chosen as a target-frame among frames of multiple cameras for facial-response evaluation of the participant. This is a novel optimization for a significant problem in actual systems that has not been addressed in any prior art or system or method.

In another embodiment of the invention, multiple cameras 501, 501a, 501b, may be used to record multiple participants that are in their recording range in each video frame. Each participant is uniquely identified by their approximate position in the image (and optionally as well by the participant's unique facial features (as in image identification by color, texture, and other features) as and when needed. By tracking using facial features, even if a participant moves across seats the participant can be uniquely identified and evaluated. The tracking using facial features may only be used when there is significant movement of a participant. Using the multiple cameras 501, 501a, 501b, the best possible sub shots are created for each participant, and adjusted, or synthesized to get the best evaluation frame for each participant.

Eye trackers, on the other hand, capture the eye fairly well even with rotation and tilt. For that reason, in one embodiment of the invention (best mode), only one eye tracker may be used. In another embodiment, if the head moves too much forward or backward the eyes may be lost on the tracker. To compensate for any loss of eye tracking, a second eye tracker may be used to adjust for a second possible horizontal distance of the head.

Heart rate and other related measures may be obtained from one or more of camera systems as well as from wrist-based sensors. Each of these measurements may also be qualified with noise levels as gleaned from the camera images, or from the accelerometer and other sensors that may indicate movement or other artifacts on the wrist.

Some vendors for facial coding output not only the seven standard/universal raw facial emotion measures (as propounded by Paul Ekman) such as joy, surprise, sadness, fear, anger, contempt and disgust but also other derived measures such as confusion, anxiety and frustration (in addition to an overall ‘derived’ positive, neutral or negative emotion). Whereas other vendors lack such measures. In such cases, wherever such output may be missing, the system could incorporate one or more machine learning models that can classify facial expression (raw action units) into these additional higher-level constructs by training on datasets with facial expression as well as user-expressed behavioral attributes for emotion. Although these measures from just facial expression may be sufficient for some applications, our experiments indicate the best behavioral outcomes are best predicted by appropriate combinations across facial coding outputs eyetracking outputs, and/or skinconductance and heartrate. In one embodiment of the invention, the emotional companion system combines fixation information, and duration on relevant content from eyetracking, followed by patterns of high skin conductance spikes and negative facial emotion may indicate various levels of confusion and anxiety in some participants. Likewise, in another embodiment, the pupil dilation levels are also included.

In one embodiment of the invention, one or more machine learning models may be created by combining physiological responses with actual participant behavioral outcomes in specific applications and such models are then incorporated as the core for the assistive feedback module in the emotion companion system.

In one embodiment of the invention, the interactive session/application can be an education training application wherein the feedback may be related to identifying confusing topics for said first participant as identified by confusion and cognition feedback measures (in addition to performance or test-score mechanisms) and the application dynamically increases or decreases of the complexity of the training material as well as selects relevant topics for subsequent presentation, training or testing based on such feedback.

In one embodiment of the invention, in an education training application, based on the profile of the participant (e.g., by age and grade level etc), the system may first create an initial customized ‘baseline content’ of various topics varying in anticipated proficiency, familiarity with such topics for that said participant. It then utilizes the baseline content as a training dataset (along with any performance scores) to identify difficulty and confusion thresholds (on various signals) for the participant and as it presents subsequent education material will utilize said training model to determine confusing content in training material and adaptively scaling up or down the complexity of content in the training material in the interactive presentation and optionally also alerting a notified administrator with a summary of weak/strong topics/areas for the participant in the presentation.

In another embodiment of the invention, the interactive session or application may be a gaming application wherein the level of complexity in the game be adaptively scaled up or down based on overall emotional performance indicators for a said participant. Here the application may be monitoring for various durations of joy, confusion, fear to be invoked in the participant and adaptively scaling up or down as needed at each stage of the game so as to keep him/her engaged effectively with the game.

In one embodiment of the invention, the emotion companion system may utilize a portion of the session to identify ranges of emotion responses for a said participant to characterize the emotion signals into various classes (such as high gsr, high joy etc.) which may in turn be combined across signals to train with, predict and identify specific behavioral outcomes using appropriate machine learning techniques.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

1. A system that can act as an assistive emotion companion for a user wherein the system is designed for capturing emotional as well as performance feedback of first participant participating in an interactive session either with a system or a second presenter participant, and utilizing such feedback to adaptively customize subsequent parts of the interactive session in an iterative manner, wherein said system comprises of emotional feedback tracking module, a feedback analysis module, an adaptive presentation configuration module where in the system is configured to:
receive one or more emotional signals from said at least one participant participating in said interactive presentation/interactive session based on one or more physiological responses for tracking emotion and cognition;
receive the physiological response from at least one or a plurality of devices attached to an interactive device system to capture the emotional signals in a consistent manner;
dynamically identify and label said at least one participant as a presenter or as a viewer based on the function performed by said at least one participant;
divide said interactive presentation/interactive session into sub-sessions;
analyze the physiological responses to determine the emotional feedback analysis report by considering said interactive session and/or sub-sessions;
integrate a machine learning model with said system to enhance the subsequent portions of the interactive presentation/interactive session that is deployed through the machine learning model; and
provide the emotional feedback analysis report as a feedback for a decision-making activity associated with said at least one interactive presentation/interactive session to customize and enhance the subsequent portions of the interactive session/interactive presentation for the first user.

2. The system as claimed in claim 1, wherein said system is configured to receive the physiological responses by measuring one or more of the biometric signals associated with said at least one participant participating in said interactive presentation/interactive session including but not limited to facial coding outputs, voice expression outputs, heart rate outputs, skin conductance outputs, gaze, eye tracking outputs, motion outputs, touch, pressure, or other related outputs.

3. The system as claimed in claim 1, wherein said system is configured to support said interactive session in the form of a video game, adaptive education training, an interactive simulation, entertainment software through one of the media to enhance the user experience for said at least one participant participating in said interactive session.

4. The system as claimed in claim 1, wherein the system is configured to dynamically label said at least one participant as a presenter, when said at least one participant is presenting a live session or streaming a video on said interactive device, or as a viewer when said at least one participant is viewing or interacting with said live session or a streamed video on said interactive device.

5. The system as claimed in claim 1, wherein the means used to divide said interactive presentation/interactive session into sub-sessions can be provided through the following ways: based on a pre-defined time interval marking the beginning and end of the sub-sessions, based on the duration of the session presented by the presenter, or based on interleaving topics in a multi-topic domain, or parts in a multi-part session/presentation.

6. The system as claimed in claim 5, wherein the system is configured to analyze the physiological response to determine the emotional feedback analysis report based on the sub-sessions identified for the interactive session and/or aggregating the emotional feedback analysis report determined for the sub-sessions after receiving the physiological response from said at least one participant.

7. The system as claimed in claim 6, wherein the presenter or the system modifies subsequent parts of interactive presentation/session based on the feedback received from said first participant in prior parts of the interactive presentation/session.

8. The system as claimed in claim 6, wherein the system configured with an education training application allows subsequent parts of presentation material to be updated based on a weighted combination of how the participant expresses confusion, frustration, joy, cognition or other emotional (emotive and cognitive) performance indicators, along with any explicit scoring mechanisms on prior parts of the presentation.

9. The system as claimed in claim 8, wherein the feedback may be related to identifying confusing topics for said first participant as identified by confusion and cognition feedback measures (in addition to performance or test-score mechanisms) and the configuration involves appropriate actions to remove such confusion such as expanding on the confusing topics with additional details and examples, or alerting a notified administrator with a summary of weak/strong topics/areas for the participant in the presentation.

10. The system as claimed in claim 6, wherein the facial coding outputs are obtained from a plurality of cameras, each positioned in an array with appropriate translation and rotation from a central camera so as to capture the first participant's face in various angles even if the first participant rotates and tilts the head.

11. The system as claimed in claim 10, wherein at each moment, the video frame from each camera is inspected and the frame that is most consistent with a near-frontal projection of the face, by comparing various components of the face such as left and right ear and their position, size, and alignment with prior measured reference frames, is utilized for evaluating facial coding output measures to be incorporated into the participant's emotional ‘feedback’.

12. The system as claimed in claim 1, wherein the system or presenter in the interactive session is represented by a virtual avatar such as a pet or some other software agent amenable to the first participant and the avatar utilizes the emotional DNA profile and other behavioral characteristics to appropriately represent the owner's behavior and emotion in second-life type games and applications.

13. The system as claimed in claim 12, wherein the system is configured to store historical emotional behavior of said first participant and tailors its responses by consulting both the emotion DNA profile, the history of the first participant, as well as a database of other histories, and associated behaviors for adaptively configuring subsequent portions of the interactive sessions based on such knowledge base.

14. The system as claimed in claim 1, wherein the system is configured to act as an assistive emotion companion for said user in one of the following ways: mimicking the behavior of the owner, complementing the owner's behavior, and/or acting as a companion wizard/advisor to improve the overall emotional well-being and performance of the owner.

15. The system of claim 13, wherein emotional performances of said first participant are tracked by the participant's location and time to create either temporal maps of a participant's emotional history or an across-participant geographical maps of participants based on various emotional or performance histories.

16. A method that can act as an assistive emotion companion for a user wherein the system is designed for capturing emotional as well as performance feedback of first participant participating in an interactive session either with a system or a second presenter participant, and utilizing such feedback to adaptively customize subsequent parts of the interactive session in an iterative manner, wherein said method comprises of:
receiving one or more emotional signals from said at least one participant participating in said interactive presentation/interactive session based on one or more physiological responses for tracking emotion and cognition;
receiving the physiological response from at least one or a plurality of devices attached to an interactive device system to capture the emotional signals in a consistent manner;
dynamically identifying and labeling said at least one participant as a presenter or as a viewer based on the function performed by said at least one participant;
dividing said interactive presentation/interactive session into sub-sessions;
analyzing the physiological responses to determine the emotional feedback analysis report by considering said interactive session and/or sub-sessions;
integrating a machine learning model with said system to enhance the subsequent portions of the interactive presentation/interactive session that is deployed through the machine learning model; and
providing the emotional feedback analysis report as a feedback for a decision-making activity associated with said at least one interactive presentation/interactive session to customize and enhance the subsequent portions of the interactive session/interactive presentation for the first user.

17. The method as claimed in claim 16, wherein said method receives the physiological responses by measuring one or more of the biometric signals associated with said at least one participant participating in said interactive presentation/interactive session including but not limited to facial coding outputs, voice expression outputs, heart rate outputs, skin conductance outputs, gaze, eye tracking outputs, motion outputs, touch, pressure, or other related outputs.

18. The method as claimed in claim 16, wherein the method supports said interactive session in the form of a video game, adaptive education training, an interactive simulation, entertainment software through one of the media to enhance the user experience for said at least one participant participating in said interactive session.

19. The method as claimed in claim 16, wherein the method dynamically labels said at least one participant as a presenter, when said at least one participant is presenting a live session or streaming a video on said interactive device, or as a viewer when said at least one participant is viewing or interacting with said live session or a streamed video on said interactive device.

20. The method as claimed in claim 16, wherein the means used to divide said interactive presentation/interactive session into sub-sessions can be provided through the following ways: based on a pre-defined time interval marking the beginning and end of the sub-sessions, based on the duration of the session presented by the presenter.

21. The method as claimed in claim 20, wherein the method analyzes the physiological response to determine the emotional feedback analysis report based on the sub-sessions identified for the interactive session and/or aggregating the emotional feedback analysis report determined for the sub-sessions after receiving the physiological response from said at least one participant.

22. The method as claimed in claim 21, wherein the presenter or the system modifies subsequent parts of interactive presentation/session based on the feedback received from said first participant in prior parts of the interactive presentation/session.

23. The method as claimed in claim 21, wherein the education training application allows subsequent parts of presentation material to be updated based on a weighted combination of how the participant expresses confusion, frustration, joy, cognition or other emotional (emotive and cognitive) performance indicators, along with any explicit scoring mechanisms on prior parts of the presentation.

24. The method as claimed in claim 23, wherein the feedback may be related to identifying confusing topics for said first participant as identified by confusion and cognition feedback measures (in addition to performance or test-score mechanisms) and the configuration involves appropriate actions to remove such confusion such as expanding on the confusing topics with additional details and examples, or alerting a notified administrator with a summary of weak/strong topics/areas for the participant in the presentation.

25. The method as claimed in claim 16, wherein the facial coding outputs are obtained from a plurality of cameras, each positioned in an array with appropriate translation and rotation from a central camera so as to capture said first participant's face in various angles even if the first participant rotates and tilts the head.

26. The method as claimed in claim 25, wherein at each moment, the video frame from each camera is inspected and the frame that is most consistent with a near-frontal projection of the face, by comparing various components of the face such as left and right ear and their position, size, and alignment with prior measured reference frames, is utilized for evaluating facial coding output measures to be incorporated into the participant's emotional ‘feedback’.

27. The method as claimed in claim 16, wherein the software system or presenter in the interactive session is represented by a virtual avatar such as a pet or some other software agent amenable to the first participant and the avatar utilizes the emotional DNA profile and other behavioral characteristics to appropriately represent the owner's behavior and emotion in second-life type games and applications.

28. The method as claimed in claim 22, wherein the method stores historical emotional behavior of said first participant and tailors its responses by consulting both the emotion DNA profile, the history of the participant, as well as a database of other histories, and associated behaviors for adaptively configuring subsequent portions of the interactive sessions based on such knowledge base.

29. The method as claimed in claim 16, wherein the method acts as an assistive emotion companion for said user in one of the following ways: mimicking the behavior of the owner, complementing the owner's behavior, and/or acting as a companion wizard/advisor to improve the overall emotional well-being and performance of the owner.

30. The method as claimed in claim 23, wherein emotional performances of said first participant are tracked by the participant's location and time to create either temporal maps of a participant's emotional history or an across-participant geographical maps of participants based on various emotional or performance histories.
